(19) United States
(12) Patent Application Publication
(10) Pub. No.: US 2008/0138184 A1
(43) Pub. Date: Jun. 12, 2008

(54) AUTOMATIC MACHINE FOR LOADING PIPETTE TIPS INTO A RACK AND A LOADING METHOD THEREOF

(75) Inventors: Yaron Carmi, Beit Shean Valley (IL); Iftah Geva, Beit Shean Valley (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: Auto Tip Ltd., Beit Shean Valley (IL)

(21) Appl. No.: 11/952,177

(22) Filed: Dec. 7, 2007

Related U.S. Application Data
(63) Continuation of application No. PCT/IL2006/000660, filed on Jun. 7, 2006.
(60) Provisional application No. 60/688,364, filed on Jun. 8, 2005.

(51) Int. Cl. B66F 11/00

(52) U.S. Cl. 414/745.7

(57) ABSTRACT

The present invention provides an automatic loading machine adapted to load laboratory pipette racks with pipette's tips. The loading is performed by vibrations. The automatic loading machine comprises (a) collecting means adapted to contain said pipette tips; (b) orientating means in communication with said collecting means; said orientating means comprising at least one conduit adapted to direct said tips to move such that their sharp dispensing edge and/or their fitting opening is directed towards the direction of movement; (c) at least one plate having at least one funnel in communication with said orientating means, adapted to force said oriented tips to fall perpendicularly towards said pipette rack to be loaded; (d) said pipette tip rack in communication with said funnel, adapted to load said pipette's tip and to slide along a rack plate; and, (e) vibrating means adapted to simultaneously orient said tips to said orientating means; move them towards said funnel; and, actuate said rack plate.

### FIELD OF INVENTION

The present invention presents an automatic machine for Loading bulk of pipette's tips and a loading method thereof. More specifically, the present invention discloses a small desktop device that adapted to load bulk bag of disposable tips into container and to arrange the tip automatically at a commercially available rack.

### BACKGROUND OF THE INVENTION

Bulks of plastic-made disposable laboratory-utilized pipette tips (tips) are currently available in various packages size. The tips are often not organized in their envelope so as laboratory assistants are required to undertake a never-ended routine of reload operation, a tedious task which costs precious labor hours. It is acknowledged that thousands of tips are utilized for an average lab per week; hence tip sorting and loading cost dozens of men work per week. Alternatively, packs of pre-organized tip racks are commercially available in at least two styles: organized tip layers being loaded as a stack of a complete layer on an empty rack, or fully loaded racks. These two are very expensive and cost about more than 50% than the bulk tips.

Few means for loading pipette tips into a pipette rack for use on a laboratory bench were disclosed in the art. Hence, U.S. Pat. No. 5,588,792 to Tiso teaches a device for loading pipette tips into reusable racks. The tips are being received from a preloaded tips magazine that contains multiple stack layers of tips that are arranged one on top of the other. The tips are configured so that each pipette tip can nest its pointed tip through an opening in the collar and inner bore of the pipette tip in the stack layer immediately below. Likewise, each pipette tip may receive the pointed tip of the pipette tip in the stack layer above.

U.S. Pat. No. 5,470,538 to Lind discloses a loading device comprising a rectangular base assembly; a pair of side plates affixed at opposite ends of the base assembly to extend upwardly therefrom; a platform assembly positioned between said pair of side plates and movably associated with said pair of side plates so that said platform may move from a first position distal of said base to a second position proximate of said base; parallel motion means for maintaining said platform assembly in a parallel relation with said base assembly while the platform assembly moves from said first position to said second position. The platform assembly is including release means for retaining a flat on said platform assembly while said platform assembly is distal of said base and for releasing said flat at a predetermined position while said platform moves toward said second position proximate said base.

U.S. Pat. No. 4,056,920 to Shields discloses an apparatus is provided for loading a plurality of articles into a receptacle having parallel rows of openings each of which is adapted to receive a respective one of the articles. The apparatus comprises at least one loading station, and preferably two loading stations, each loading station including means for guiding and supporting the articles in a row parallel to and spaced above and laterally of a row of the openings to be filled with the row of articles. The guiding and supporting means include movable guide means for engaging the row of articles laterally. The apparatus further includes means for moving the movable guide means between a position in which the movable guide means laterally engages the row of articles and a position in which the movable guide means is disengaged from the row of articles. Carrying means are provided for the row of articles, means for moving the carrying means into engagement with the articles thereby to provide support for and carry the articles when the movable guide means is disengaged from the articles and for then moving the carrying means with the row of articles carried thereby laterally toward and into vertical alignment with the openings of the row of openings to be filled with the row of articles.

U.S. Pat. No. 5,570,566 to Newcomb discloses an apparatus that facilitates loading of disposable, tapered, plastic pipette tips into an array of apertures of a tip holder. This apparatus comprises (i) a closed container having walls defining sides, a lid which may be opened, and a floor containing at least one field of discrete openings, each for receiving a single tip, having a pattern corresponding to the pattern of said array, the openings being so sized that their margins grip the tips near their larger diameter ends. The apparatus also comprises (ii) powered means connected with the container for subjecting it to periodic motion which causes tips placed therein to be agitated and become lodged in the openings; and (iii) the vertical distance between the floor and the lid being correlated with tip length so as to minimize the risk that tips will nest in other tips already lodged in openings.

U.S. Pat. No. 5,426,911 to Poplin discloses a system for transporting by gravity a single-file series of elongate, tapered articles along an inclined transport path for distribution into receiving slots. The system includes a hopper for holding a supply of the articles and a pair of adjacently parallel rotating cylinders for holding the articles in suspended, sliding contact therebetween. A cleated conveyor belt carries the articles from the bottom of the hopper to a point above the cylinders and drops them onto said cylinders. The base of the hopper defines an inclined movement path to thereby convey articles which might fall from the cylinders back to the conveyor belt. The articles are thus fed by the conveyor onto the cylinders and slide along the gap therebetween to an end location. A series of three gates manipulates the articles one at a time to drop in a vertical orientation into an array of narrowly-tailored receiving slots in a packing rack.

U.S. Pat. No. 5,335,481 ('481) to Ward discloses an apparatus for automated loading of pipette tips (26) into storage containers or racks (28). The apparatus (21, 21a) includes a tip-orienting roller assembly (22, 22a) for orienting the lips (26) in side-by-side contact and general parallel alignment, and a spacer assembly (24, 24a) which engages the tips (26) and pushes them from the orienting assembly (22) while simultaneously spacing them at a spacing suitable for insertion into a storage container or rack (28) having spaced apart tip-receiving openings (81). In the preferred embodiment, the tip orienting assembly (22) is provided by a vibratory feeder (30) which feeds a pair of spaced apart and inclined counter-rotating rollers (36, 37), and the spacer assembly (24) pushes the tips (26) between the rollers (36, 37) and into an intermediate transfer nest assembly (27, 27a). The nest assembly (27, 27a) transfers between the roller assembly (23) and the pipette tip rack or box (28).

The main difference between patent '481 and the present invention is the fact that in the present invention the rack is actuated by vibration means which simultaneously actuates the tips to orient and move to the right direction.

Hence, a small, cost effective, simple constructed and bench or desk suitable laboratory-scale tip loader, enabled by rapid and simple operation loading mechanism which avoids spending expensive working time, and avoids the requirement of purchasing expensive pre-organized racks the is still a long felt need.

### SUMMARY OF THE INVENTION

It is one object of the present invention to disclose an automatic loading machine adapted to load laboratory pipette racks (8) with pipette's tips (9); wherein said loading is performed by vibrations.

It is another object of the present invention to disclose an automatic loading machine as defined above, wherein said machine comprising:
a. collecting means (1) adapted to contain said pipette tips;
b. orientating means (2) in communication with said collecting means (1); said orientating means comprising at least one conduit adapted to direct said tips to move such that their sharp dispensing edge 92 and/or their fitting opening 91 is directed towards the direction of movement;
c. at least one plate (3) having at least one funnel (34) in communication with said orientating means, adapted to force said oriented tips to fall perpendicularly towards said pipette rack to be loaded (g);
d. said pipette tip rack (8) in communication with said funnel, adapted to load said pipettes and to slide along a rack plate (5); and,
e. vibrating means (4) adapted to simultaneously orient said tips to said orientating means (2); move them towards said funnel; and, actuate said rack plate (5).

It is another object of the present invention to disclose an automatic loading machine as defined above, wherein said orientating means (2) is adapted to be coupled to said collecting means (1) horizontally; further wherein said orientating means (2) is adapted to sort said pipette tips by forcing said pipette tips to fall through an aperture (22) to said plate (3).

It is another object of the present invention to disclose an automatic loading machine as defined above, wherein said loading machine adapted to operate in a batchwise process, wherein said collecting means are adapted to contain about 100 to about 1,000 tip per batch.

It is another object of the present invention to disclose an automatic loading machine as defined above, adapted to operate continuously, wherein said collecting means are adapted to deliver about 10 to about 1000 tips per minute.

It is another object of the present invention to disclose an automatic loading machine as defined above, wherein said conduits (2) are at least partially open tunnels being continuously vibrated such that said tips vibrated thereon and move forward, i.e., to said at least one funnel (34) in said at least one plate (3), while being oriented such that their sharp dispensing edge 92 and/or their fitting opening 91 is directed towards the moving direction.

It is another object of the present invention to disclose an automatic loading machine as defined above, useful for loading pipette tip rack having an array of bores arranged in rows and columns; each bore is adapted by means of size and shape to accommodate one tip, such as its sharp dispensing edge is directed downwards.

It is another object of the present invention to disclose an automatic loading machine as defined above, adapted to store the tips to be loaded wherein said vibrated machine additionally comprising sorting means, useful for sorting the tips to be loaded such as only tips that are characterized by a specific size, weight or shape are loaded into said pipette tip rack (8).

It is another object of the present invention to disclose a method of loading pipette tips rack with pipette tips from a bulk by means of a vibrated loading machine. The method comprises step selected inter alia from (a) obtaining a loading machine as defined above; (b) collecting a bulk of said tips into said collecting means (1); and, (c) loading said pipette tips rack (8) with said pipette tips; wherein said step of loading said pipette tips rack (8) is performed by applying vibration by means of said vibrating means (4).

It is another object of the present invention to disclose the method as defined above, additionally comprising steps of placing at least one empty pipette tip rack (8) on rack plate (5); providing the vibrator (4) to actuate the tips in a predetermined measure, so the tips are running over the main plate (2), while orienting said tips so as their sharp dispensing edge 92 and/or their fitting opening 91 is maneuvered towards the motion direction; accommodating a plurality of conduits with said oriented tips; dispensing the same via a first aperture (22) and dropping said tips downwards to said lower plate (3); moving said tips vertically along the course of said lower plate (3) towards second aperture (33) which is positioned at the end of said course; said aperture (33) has a larger diameter in compare with said course, so as each of the tips is dropping downwards to said pipette tip rack (8) to be loaded such that said sharp edge (92) of said tip faces said pipette tip rack (8); loading a first row or column of said pipette tip rack (8); placing another row or column below second aperture (33); moving rack (8) so as said tips accommodating second aperture (33) are not lying on the tips that already in said pipette tip rack (8).

It is another object of the present invention to disclose the method as defined above, additionally comprising step of sorting said tips such that only tips characterized by a predetermined size, weight or shape shall be loaded.

It is another object of the present invention to disclose a batchwise loading method as defined above.

It is another object of the present invention to disclose a continuous loading method as defined above.

It is still an object of the present invention to disclose the method as defined above, additionally comprising step of repeatedly moving said pipette tip rack (8) until the last row or until all the rows and columns of holes in said pipette tip rack (8) are accommodated by said tips.

It is lastly an object of the present invention to disclose the method as defined above, wherein said step of loading said pipette tips rack (8) with said pipette tips additionally comprises steps of:
a. actuating said tips in a plurality of conduits, while orienting the same such that their sharp dispensing orifice is directed towards the moving direction;
b. dispensing said oriented tips throughout said at least one funnel (34) in said plate (3) hence accommodating one or more column and/or line of the bores of said pipette tips rack (8) with tips; and,
c. sliding said pipette tip rack (8) on top of said rack's plate (5), such that another one or more column and/or line of the bores of said pipette tips rack (8) is accommodated with tips until all bores are accommodated with tips.

### BRIEF DESCRIPTION OF THE FIGURES

In order to understand the invention and to see how it may be implemented in practice, a preferred embodiment will now be described, by way of non-limiting example only, with reference to the accompanying drawing, in which

FIG. 1 presents a lateral cross section of a commercially available pipette tip;

FIG. 2 schematically presents a perspective view of the loading machine according to one embodiment of the present invention; and,

FIG. 3 presents a close view of the sorting/loading means of the loading machine according to yet another embodiment of the present invention.

### DETAILED DESCRIPTION OF THE EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an automatic vibrated machine for loading laboratory pipette racks with pipette's tips stored in a bulk and a method thereof.

The present invention provides a novel automatic loading machine, especially yet not exclusively, a small-scale device, adapted to load laboratory pipette racks with pipette's tips stored in a bulk.

This effective machine comprising (a) collecting means adapted to contain at least a portion of said bulk; (b) orientating means, comprising a plurality of conduits directing the tips to move wherein their sharp dispensing orifice is directed towards the moving direction; (c) at least one funnel, adapted to force a series of oriented tips to move perpendicularly towards a loaded rack; (d) said pipette tip rack, adapted to slide along a rack plate; and, (e) vibrating means adapted to simultaneously orient said tips, move them towards the descending funnel, and actuate the rack on top of its plate.

It is in the scope of the present invention wherein the above mentioned loading machine is adapted to operated either batchwise, wherein the collecting means are adapted to contain about 100 to about 1,000 tip per batch or continuously, wherein the collecting means are adapted to deliver about 10 to 1000 tips per minute.

Another object of the present invention is to disclose a small scale, laboratory scale or large scale method of loading pipette tips rack with pipette tips from a bulk by means of a vibrated loading machine. The method comprising inter alia the steps of (a) collecting a bulk of tips in a container; (b) applying vibration by means of vibrating means; (c) actuating said tips in a plurality of conduits, while orienting the same such that their sharp dispensing orifice is directed towards the moving direction; (d) dispensing said oriented tips throughout at least one funnel hence accommodating one or more column and/or line of the bores of said pipette tips rack with tips; (e) sliding said rack on top of a rack's plate, such that another one or more column and/or line of the bores of said pipette tips rack with tips until all bores are accommodated with tips.

The method may additionally comprising the step of sorting of said oriented tips such that tips characterized by a predetermined size or shape shall be loaded.

It is acknowledged in this respect that either batchwise and/or continuous loading method is hereto discloses.

The term “batchwise process” refers hereinafter to a process used to produce or process any product in groups that can be called batches, as opposed to a continuous production process.

The term “Continuous production” refers hereinafter to a process used to manufacture, produce, or process any product without interruption. There is no discrete rate at which goods are produced, as opposed to a batch production process, or a one-time production.

The term “about” refers hereinafter to refers hereinafter to a range of 25% below or above the referred value.

The term “actuate the rack plate (5)”, “pipette tip rack (8)” refers hereinafter to sliding the rack plate (5) which eventually slides the tip rack (8) such that row or column are placed below the apertures (33) so as the tips accommodating the aperture (33) are not lying on the tips that already in the pipette tip rack (8). Furthermore those terms refers to repeatedly moving the pipette tip rack (8) until the last row or until all the rows and columns of holes in the pipette tip rack (8) are accommodated by the tips.

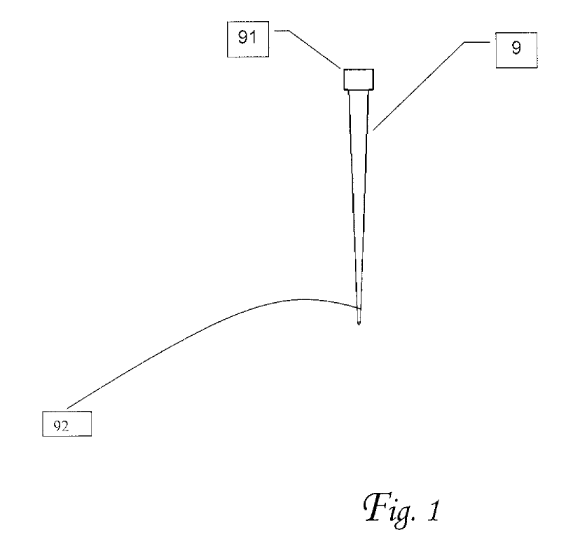

Reference is made now to FIG. 1, schematically presenting a lateral cross section of one or many commercially available pipette tips. Those disposable tips are available in various shapes and sizes, and usually made of plastic and suitable for dispensing predetermined volumes of fluids and liquids (e.g., 10 μl to 500 ml) by a means of calibrated pipettes. Tip (9) is an elongated cone having a main longitudinal axis, having a narrow dispensing edge 92 at one end and a wider fitting opening (91) at the other end. The tip's fitting opening is adapted to reversibly accommodate the pipette dispensing end. Hence, said tip is load in a tip's rack solely at a perpendicular orientation, wherein its narrow dispensing orifice is immobilized in the rack, and fitting opening protruding upwards.

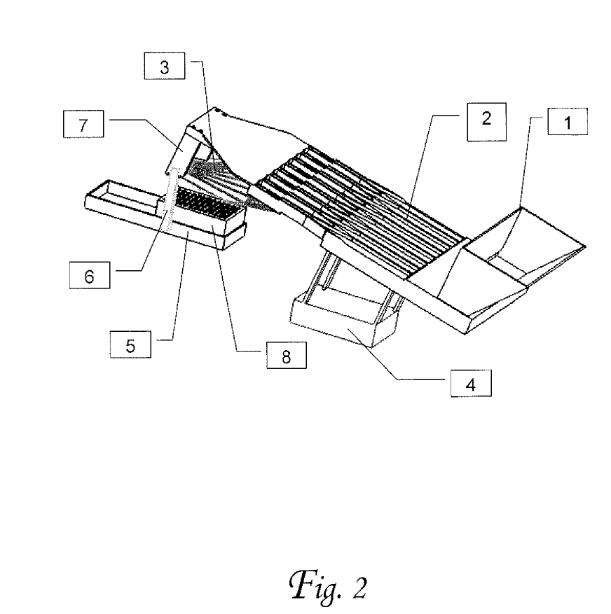

Reference is made now to FIG. 2, presenting a perspective look of a pipette tips loading machine according to one embodiment of the present invention, wherein tips container (1) is adapted to accommodate bulk of tips. e.g., about 1,000 tips per batch or 1 to about 100 tips per minute, main plate (2) and lower plate (3), a linearly actuated vibrating means (4), a rack plate (5), lower (6) and upper (7) bridge, and tips rack (8). As can be seen from the figure the main plate (2) is held with horizontally but with an incline or a slope.

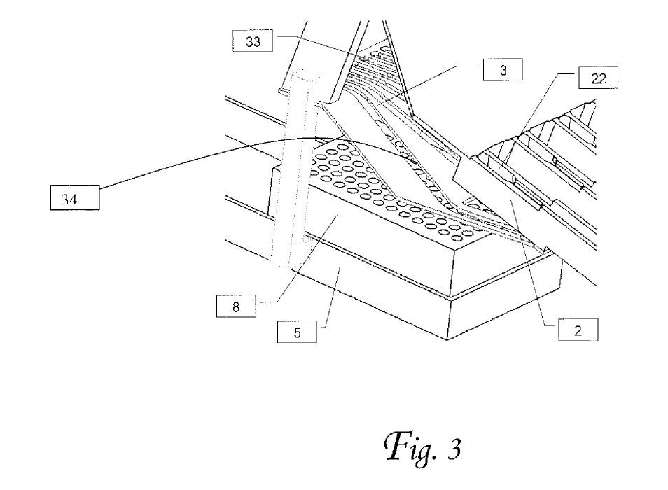

It is further in the scope of the present invention wherein the laboratory assistant operating the loading machine dispenses a bag with bulk of tips into container (1), and places at least one empty pipette tip rack (9) on rack plate (5). The vibrator (4) actuate the tips in a predetermined measure, so the tips start to run over the main plate (2), while the tips are directed to an orientation wherein their sharp edge is maneuvered towards the motion direction. Then, oriented tips are accommodated in a plurality of conduits, comprising a first aperture (See 22, FIG. 3) at its very end and drop downwards to the lower plate (3). Lower plate (3) has at least one funnel 34.

Each tip falls to the lower plate 3 while its sharp edge (92) faces up (i.e away from the pipette rack (8)). This is due to the fact that the tip's center of mass is not positioned in it's geometrical center.

Reference is made now to FIG. 3, presenting a closer view of the same. Oriented tips move now vertically along the course at the lower plate (3) towards second aperture (33) which is positioned at the end of said course. Aperture (33) has a larger diameter in compare with said course, so as each of the tips is dropping downwards to a loaded pipette tip rack (8), and placed at one of the rack's holes. Each tip falls into the pipette rack (8) while it's sharp edge (92) faces down. This is due to the fact that each funnel 34 holds the tip in it's wider fitting opening (91), therefore when the tips fall into the pipette tip rack (8) they fall while the sharp edge (92) faces down.

Said perpendicular dropping movement throughout second aperture (33) is provided whereat the tip is fully vertically oriented, and not to lean on the tip fitting opening (91).

Subsequently, pipette tip rack (8) moves forward due to the vibrations applied on the loading machine, and delivered through upper bridge (7) and lower bridge (6). The vertical distance between rack (8) and lower plate (3) is few millimeters smaller than the tip length, so in order to drop downwards from second aperture (33) to an empty hole at the rack (8), said hole must be free of tips. Furthermore, the lower plate (3) adjust the pipette tips to the rack array's (8) proportions and enables the pipette tip to fall into the rack hole when are synchronized.

After loading a first row or column of loaded rack (8), a following row or column is now placed below second aperture (33). Said rack (8) moves now forward so as the tips accommodating second aperture (33) are not lying on the tips that already at the rack (8), and so on and so forth until the last row or column of holes at the rack (8) are occupied by tips.

It is also in the scope of the present invention wherein the vibrated machine defined in any of the above additionally comprises sorting means, useful for sorting the tips to be loaded such as only tips that are characterized by a specific size, weight or shape shall be loaded in the rack.

It is also in the scope of the invention wherein the vibrated machine will comprise returning means adapted to return the pipette tips which do not fall through the upper tray's (i.e. main plate (2)) aperture (22), to the container (1).

The important feature of the present invention is that it provides a machine that enables sorting and loading pipette tips into pipette tips rack (8) by using only vibrations. Furthermore, the present invention provides a machine that is adapted to fit and to be place on top of a desk.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. An automatic loading machine adapted to load laboratory pipette racks (8) with pipette's tips (9); wherein said loading is performed by vibrations.

2. The automatic loading machine according to claim 1, wherein said machine comprises:
a. collecting means (1) adapted to contain said pipette tips;
b. orientating means (2) in communication with said collecting means (1); said orientating means comprising at least one conduit adapted to direct said tips to move such that their sharp dispensing edge 92 and/or their fitting opening 91 is directed towards the direction of movement;
c. at least one plate (3) having at least one funnel (34) in communication with said orientating means, adapted to force said oriented tips to fall perpendicularly towards said pipette rack to be loaded (8);
d. said pipette tip rack (8) in communication with said funnel (34), adapted to load said pipette's tip and to slide along a rack plate (5); and,
e. vibrating means (4) adapted to simultaneously orient said tips to said orientating means (2); move them towards said funnel (34), and, actuate said rack plate (5).

3. The loading machine according to claim 2, wherein said orientating means (2) is adapted to be coupled to said collecting means (1) horizontally; further wherein said orientating means (2) is adapted to sort said pipette tips by forcing said pipette tips to fall through an aperture to said plate (3).

4. The loading machine according to claim 3, wherein said loading machine adapted to operate in a batchwise process, wherein said collecting means are adapted to contain about 100 to about 1,000 tip per batch.

5. The loading machine according to claim 3, adapted to operate continuously, wherein said collecting means are adapted to deliver about 10 to about 1000 tips per minute.

6. The loading machine according to claim 3, wherein said conduits (2) are at least partially open tunnels being continuously vibrated such that said tips vibrated thereon and move forward, i.e., to said at least one funnel (34) in said at least one plate (3), while being oriented such that their sharp dispensing edge 92 and/or their fitting opening 91 is directed towards the moving direction.

7. A vibrated machine according to claim 3, useful for loading pipette tip rack having an array of bores arranged in rows and columns; each bore is adapted by means of size and shape to accommodate one tip, such as its sharp dispensing edge (92) is directed downwards.

8. A vibrated machine according to claim 3 or any of its dependent claims, adapted to store the tips to be loaded wherein said vibrated machine additionally comprising sorting means, useful for sorting the tips to be loaded such as only tips that are characterized by a specific size, weight or shape are loaded into said pipette tip rack (8).

9. A method of loading pipette tips rack with pipette tips from a bulk by means of a vibrated loading machine, said method comprising:
a. obtaining a loading machine according to claim 3, or in any of its dependent claims;
b. collecting a bulk of said tips into said collecting means (1); and,
c. loading said pipette tips rack (8) with said pipette tips;
wherein said step of loading said pipette tips rack (8) is performed by applying vibration by means of said vibrating means (4).

10. The method according to claim 9, additionally comprising steps of placing at least one empty pipette tip rack (8) on rack plate (5); providing the vibrator (4) to actuate the tips in a predetermined measure, so the tips are running over the main plate (2), while orienting said tips so as their sharp dispensing edge 92 and/or their fitting opening 91 is maneuvered towards the motion direction; accommodating a plurality of conduits with said oriented tips; dispensing the same via a first aperture (22) and dropping said tips downwards to said lower plate (3); moving said tips vertically along the course of said lower plate (3) towards second aperture (33) which is positioned at the end of said course; said aperture (33) has a larger diameter in compare with said course, so as each of the tips is dropping downwards to said pipette tip rack (8) to be loaded such that said sharp edge (92) of said tip faces said pipette tip rack (8); loading a first row or column of said pipette tip rack (8); placing another row or column below second aperture (33); moving rack (8) so as said tips accommodating second aperture (33) are not lying on the tips that already in said pipette tip rack (8).

11. The method according to claim 9, additionally comprising step of sorting said tips such that only tips characterized by a predetermined size, weight or shape shall be loaded.

12. A batchwise loading method according to claim 9 or any of its dependent claims.

13. A continuous loading method according to claim 9 or any of its dependent claims.

14. The method according to claim 9, additionally comprising step of repeatedly moving said pipette tip rack (8) until the last row or until all the rows and columns of holes in said pipette tip rack (8) are accommodated by said tips.

15. The method according to claim 9, wherein said step of loading said pipette tips rack (8) with said pipette tips additionally comprises steps of:
a. actuating said tips in a plurality of conduits, while orienting the same such that their sharp dispensing orifice is directed towards the moving direction;
b. dispensing said oriented tips throughout said at least one funnel (34) in said plate (3) hence accommodating one or more column and/or line of the bores of said pipette tips rack (8) with tips; and,
c. sliding said pipette tip rack (8) on top of said rack's plate (5), such that another one or more column and/or line of the bores of said pipette tips rack (8) is accommodated with tips until all bores are accommodated with tips.
